(19) United States
(12) Patent Application Publication
(10) Pub. No.: US 2006/0228689 A1
(43) Pub. Date: Oct. 12, 2006

(54) Interactive tutorial system and method

(76) Inventor: Kishore K. Rajaram, Irving, TX (US)

Correspondence Address: MICHAEL L. DIAZ, P.C., 555 REPUBLIC DRIVE, SUITE 200, PIANO, TX, 75074, US

(21) Appl. No.: 11/103,935

(22) Filed: Apr. 12, 2005

(51) Int. Cl. G09B 3/00

(52) U.S. Cl. 434/350

(57) ABSTRACT

The present invention is an intelligent interactive tutorial system. The tutorial system includes a computing system having artificial intelligence, which enables the communication in a two-way conversation mode between a student at a computer station and the computing system thereby facilitating anytime one-on-one individual assistance for the student. The computing system provides tutoring on a specific curriculum and/or a specific subject matter. The tutoring includes assistance on problems or questions associated with a specific textbook in any subject matter or other course load assigned to the student. The student may optionally communicate with a live tutor if further assistance is necessary.

### BACKGROUND OF THE INVENTION

1. Field of the Invention

This invention relates to education. Specifically, and not by way of limitation, the present invention relates to an interactive tutorial system.

2. Description of the Related Art

Without a doubt, the education of students, more specifically children, is of paramount importance in today's society. However, although the importance of education is unquestioned, there are many difficulties in how to most effectively accomplish educating students. Because of these difficulties, clearly, there are obvious student achievement issues faced by every educator. Currently, there are many companies offering supplemental academic material to students. The assumption is that the current curriculum offered by schools is insufficient. To solve this perceived problem, these companies often provide additional expensive coursework to a student's workload to supplement the school curriculum. However, in reality, there are massive efforts taken by the school authorities, parents, and state agencies to choose the current curriculum, such as homework, textbooks, etc. Recent research suggests that when online, 92% of students spend many hours attempting research to help with their daily homework given from their textbooks, etc. However, because of the tedious nature of this additional research, which often is unsuccessful, students are unmotivated to even attend their class the next day. Therefore, the problem is not necessarily the need for additional coursework that may overwhelm even the best of students. Rather, the problem is to cater directly to the students' everyday needs on their existing curriculum, such as their daily homework help needs from their textbooks (practice/exercise problems, etc), help in test preparation for the SAT, state mandated testing, etc.

Also, in the past, parents and guardians provided much of the supplementation of instruction and assistance in schoolwork for a child. However, in today's fast-paced world, parents or guardians simply do not have the time to assist children in schoolwork. Children often receive supplementary assistance from teachers at their schools in areas where they are having difficulties. However, with the overcrowding of students and severe shortage of qualified teachers, school authorities simply do not have the additional resources to effectively assist all those students needing assistance with their schoolwork. Additionally, many students find it extremely inconvenient to seek and receive this additional instruction from teachers, who are quite often not highly qualified in the specific subject matter. Oftentimes, this additional tutoring takes place immediately before or after school rather than at a time and place of the student's preference. Students want to get help badly, but at their convenience. In addition, they want to get help with someone such that, “that someone” is willing to accept their idiosyncrasies and willing to encourage them throughout their learning process. Because of a lack of such valuable resources, ultimately, the students suffer. This results in lower grades, an increase in student dropouts, decrease in daily attendance, and many other major problems for the schools, teachers, and the parents' community.

Students have looked to other ways of obtaining assistance in completing their schoolwork. Students may privately employ live tutors to assist in understanding and completing their school studies. But tutors can be very expensive. In addition, due to the exorbitant costs, school districts often do not provide the private tutors and, thus, the parents of the student must pay the exorbitant additional costs.

With the Internet, oftentimes students look to online assistance. But existing on-line assistance takes one of two forms. Either the student speaks directly with a live tutor or the student uses a website which provides content in specific subject matter for which the student desires assistance. In the first case, use of a live tutor over the Internet is merely a communication tool via phone or instant messaging allowing distance learning program and still requires an individual tutor. The cost of an online tutor can still be expensive. Besides, oftentimes these online tutors are not qualified and a good majority of them do this as a part-time job from their homes, thereby significantly affecting the quality of education provided by them. In the second case, the student enters a website and is provided with additional computerized assistance in a specific subject matter. However, these online tutorial sessions are very restrictive. The student is unable to interact with the website in a fashion which enables the student to fully understand the subject matter. In addition, the instruction is merely a computerized course, which does not factor into the specific curriculum/textbook for which the student is studying. The website merely provides additional overwhelming content at random, which means more work for a student, rather than providing direct assistance with the student's specific query from the current curriculum. This is exactly where the educators see students getting disengaged, frustrated, unmotivated, and ultimately loosing interest in the subject matter. Oftentimes, this damage done to the students has a lifetime impact making them uninterested to aspire for higher educational and career goals in their individual lives. A system and method is needed which provides a competent and cost-effective tutorial system and method for students requiring around the clock assistance in understanding any specific subject matter directly from his or her specific course curriculum, including any specific textbook and any other reference material.

Although there are no known prior art teachings of an apparatus or system such as that disclosed herein, prior art references that discuss subject matter that bears some relation to matters discussed herein are U.S. Pat. No. 6,634,887 to Heffernan, III et al. (Heffernan), U.S. Pat. No. 5,597,312 to Bloom et al. (Bloom), U.S. Pat. No. 6,430,602 to Kay et al. (Kay), U.S. Patent Application Publication Number US 2004/0058304 to Morsy et al. (Morsy), and U.S. Pat. No. 6,733,295 to Stuppy et al. (Stuppy).

Heffernan discloses a method and system for tutoring a student. Heffernan utilizes a student model for diagnosing student input and a tutorial model for deciding what new questions to plan to ask the student. However, Heffernan does not teach or suggest an interactive tutorial system, which enables a student to chat with the tutorial system and ask specific questions. Heffernan merely discloses a system, which reacts to the students' answers by modifying a student teaching model. By design, Heffernan does not teach or suggest providing tutorial assistance in all subject matters. The system is restricted mostly to numerical problems. The system also has some restrictive parameters on students' questions thereby making it an inefficient system that fails to deliver tutoring based on each student's intelligence level. Furthermore, Heffernan does not provide an insertion of graphic images of any kind or an electronic equivalent of a blackboard that is critical for teaching students of various age groups while providing hints, asking relevant questions, etc. The system does not support additional around the clock highly qualified live one-on-one tutor access of any kind. In addition, Heffernan does not teach or suggest providing tutorial assistance to a specific course curriculum.

Bloom discloses a computer-based method and system for tutoring a student in an interactive application, specifically suggested for Customer Service Representatives (CSRs) applications. The system selects a mode of teaching, generating a student model and monitoring a student task based upon the teaching mode. An updated student model is presented in response to the student task status. However, Bloom does not disclose an interactive exchange where the student may ask questions or provide a conversation mode of teaching. The system does not supplement around the clock highly qualified live one-on-one tutor access of any kind. In addition, Bloom does not teach or suggest a system which provides tutorial assistance associated with a specific course curriculum.

Kay discloses a system and method of interactively responding to queries from a remotely located user. A computer server is configured to receive an instant message query or request from the user. The query or request is interpreted and appropriate action is taken, such as accessing a local or remote data resource and formulating an answer to the user's query. The answer is formatted and sent to the user. However, Kay does not teach or suggest providing an interactive tutorial session. In addition, Kay does not teach or suggest providing assistance for a specific course curriculum.

Morsy discloses an interactive learning toy employing a closed educational loop that encompasses obtaining written and spoken responses characteristic to the user. The user's characteristic response is recognized via handwriting and speech recognition techniques and educational feedback is communicated to the user. However, the interactive process of Morsy is merely a closed loop learning process, which utilizes a computing system to evaluate responses from users based on queries from the computing system. Morsy does not teach or suggest an interactive tutorial system which enables the computing system to respond to specific questions presented by the user. In addition, Morsy does not teach or suggest a system, which provides tutorial assistance for a specific course.

Stuppy discloses a learning system having a teacher station and a plurality of student stations. The teacher station allows an interactive communication channel to communicate with one of the student stations. As a result, the teacher separately interacts with each of the plurality of students over a selected interactive communication channel. However, Stuppy does not teach or suggest an automated tutorial system of any kind, which provides assistance for a specific course curriculum.

A system and method are needed which provides an interactive automated tutorial session with a student. The system should be able to assist the student with any number of specific problems in any subject matter from any part of their textbooks, or other course curriculum materials at anytime in a conversation mode. Thus, it would be a distinct advantage to have an interactive tutorial system and method providing methodical instruction and high quality assistance to a student at anytime on a specific course curriculum. It is an object of the present invention to provide such a system and method.

### SUMMARY OF THE INVENTION

In one aspect, the present invention is an interactive tutorial system. The interactive tutorial system includes a computing system having an artificial intelligence module and a memory module. A student computer station for use by a student desiring tutoring in a specific subject matter communicates with the computing system. The artificial intelligence module generates instruction on the specific subject matter stored within the memory module for the student. The artificial intelligence is capable of interacting with the student in a two-way conversational mode. The computing system may include instruction teaching modules on a specific course curriculum and any associated coursework. In addition, the computing system provides additional hints, encouraging feedback, relevant graphical images, and asks relevant intelligent questions for each task accomplished or each question posed by the student. The tutorial system may also optionally provide access to a live tutor through the computing system to the student as necessary.

In another aspect, the present invention is a method of providing an interactive tutorial session to a student in any specific subject matter from any specific curriculum. The method begins by a student initiating contact with the computing system via a student computer station. The computing system has the artificial intelligence and all the appropriate data generated in memory on that specific subject matter. Next, the student selects a specific subject matter for which the student needs tutoring. The student can select a specific subject matter, such as any practice or exercise problem or any question within a textbook, to receive tutoring upon. Without giving any type of direct answers to that specific problem, the computing system responds by providing additional hints, relevant instructions, encouraging feedback, and poses relevant intelligent questions to the student on the specific subject matter. Through the artificial intelligence of the computing system, the student and computing system engage in a two-way conversation on the specific subject matter. The computing system may also provide feedback on each task accomplished by the student. The computing system may also provide access to a highly qualified live tutor to supplement the instruction provided by the computing system.

In still another aspect, the present invention is an interactive tutorial system having a computing system with an artificial intelligence module and a memory module. The memory module stores information on a specific course curriculum. A student desiring tutoring in the specific course curriculum, such as a textbook and its associated homework problems etc, uses a student computer station. The student computer station communicates with the computing system. The artificial intelligence module generates internal commands and subsequently the instructions stored within the memory module for the student. The artificial intelligence is capable of responding to any query by the student. The artificial intelligence may also provide relevant feedback on each task accomplished by the student.

### BRIEF DESCRIPTION OF THE DRAWINGS

FIG. 1 is a simplified block diagram of an interactive tutoring system in the preferred embodiment of the present invention;

FIG. 2 is an exemplary screenshot utilized within the interactive tutoring system of FIG. 1; and

FIGS. 3A-3C are flow charts outlining the steps for utilizing the interactive tutoring system according to the teachings of the present invention.

### DESCRIPTION OF THE INVENTION

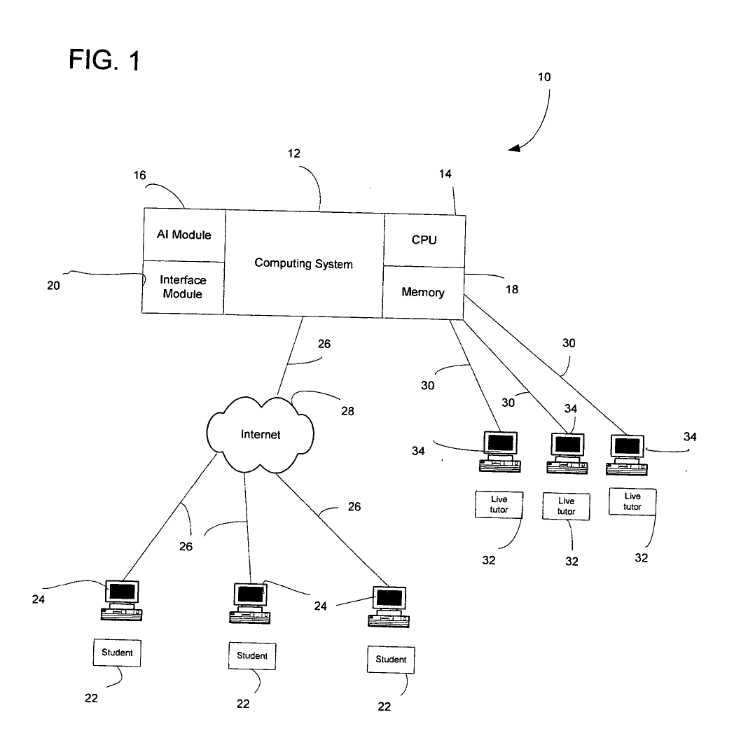

The present invention is an interactive tutorial system and method. FIG. 1 is a simplified block diagram of an interactive tutoring system 10 in the preferred embodiment of the present invention. The interactive tutoring system includes a computing system 12 having a central processing unit (CPU) 14 with an artificial intelligence module 16, a memory 18, and an interface module 20. The computing system communicates with one or more students 22 through student computer stations 24. In the preferred embodiment of the present invention, the student computer station is a conventional personal computer having a monitor, a keyboard and a CPU. However any communication device allowing communication with the computing system may be used by the student. The student computer station communicates with the computing system through a communication link 26. Preferably, the communication link is established via the Internet 28. However, any communication link and network may be used to provide communication between the student and the computing system. For example, the student may communicate through a virtual private network.

The CPU 14 may be any computer processor capable of operating the artificial intelligence module 16. The artificial intelligence module enables the computing system to provide specific artificial intelligence capabilities, such as a conversational mode between the student 22 and the computing system. The memory 18 may store one or more specific academic modules. An academic module may be a teaching module for a specific course or courses having an associated textbook or other reading/homework material. The teaching module for the textbook and any associated information are preferably stored within the memory. In addition, the memory may include stored instructions for each specific topic or problems within the textbook/homework.

The tutoring system 10 may optionally include a communication link 30 linking the student 22 via the computing system 12 to a live tutor 32. The computing system communicates with one or more students 22 through student computer stations 24 and with one or more live tutors 32 through tutor computer stations 34 and establishes connection between one student with one tutor at a time using an electronic equivalent of the classroom board, called the whiteboard. In some other rare instances, many students are connected to just one tutor. The live tutor is a human communicating one-on-one with the student through a tutor computer station 34. The tutor computer station may be any computer allowing a communicative dialog with the student. In the preferred embodiment of the present invention, the tutor computer station is a conventional personal computer having a monitor, a keyboard and a CPU. The student may ask questions directly to the tutor if necessary to get one-on-one individual assistance in any schoolwork problem or concept at practically anytime in a day.

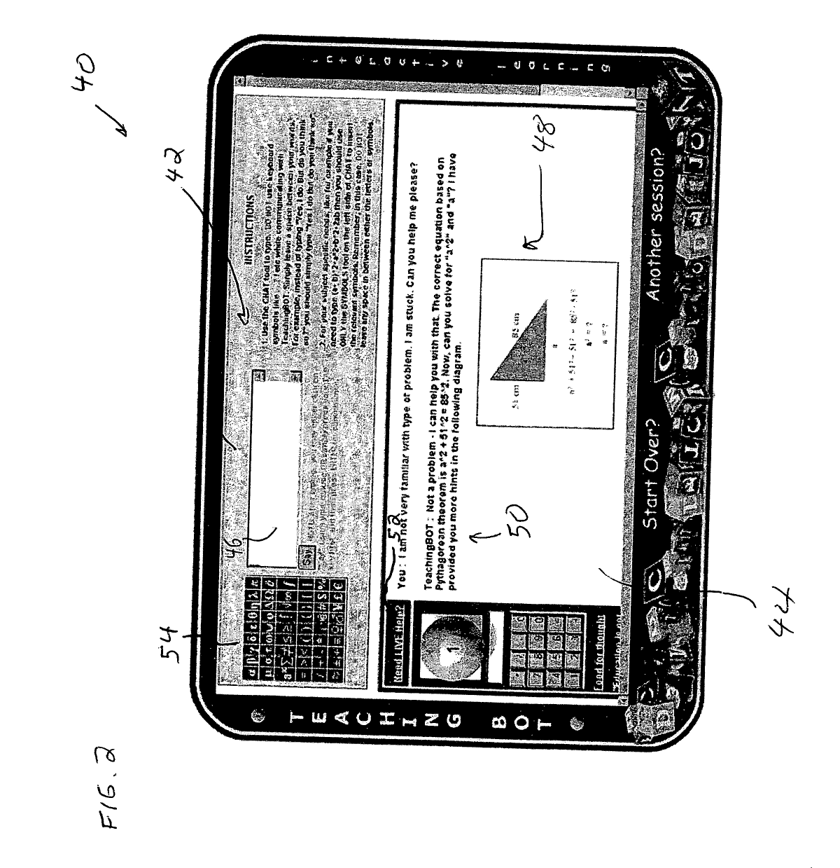

FIG. 2 is an exemplary screenshot 40 utilized within the interactive tutoring system 10 of FIG. 1. The screenshot is generated by the interface module 20 of the computing system 12 to the student 22 through the student computer station 24. The screenshot may include a student response section 42 and a tutor query section 44. Within the student response section is a virtual keyboard 54 and a data input section 46. The keyboard may include conventional alphanumeric and mathematical symbols as necessary for the specified course. The tutor query section includes a block area 48 providing questions to the student. As depicted for an example, a problem associated with Pythagorean's Theorem on triangles is presented to the student. In addition, a chat format block area 50 is provided, showing both the last text messages from both the student and tutoring system. The chat format block area enables the computing system to “chat” in a conversational mode with the student. The screenshot may also include a live help request section 52. Clicking upon the live help request provides a request for a live tutor 32. The screenshot may change to provide additional space for a whiteboard to allow further communication capability between the live tutor and the student. Although the screen provides a unique interactive experience for the student, any screenshot may be utilized which enables the student to communicate on a conversational basis with the computing system.

With reference with FIGS. 1-2, the operation of the interactive tutoring system 10 will now be explained. One or more students 22 log onto the computing system 12 through the student computer station 24 via the communication link 26 directly to the interface module 20. The computing system 12 queries the student for a specific subject. The student responds with the specific course. The computing system may need information on the student and course, such as student name, school district, state, city, etc. In addition, the specific course name or textbook may need to be provided, such as Algebra I at Piano ISD, Texas. The computing system accesses the requested teaching module from the memory 18. Stored within the memory 18 is the teaching module for the specified course. In addition, stored within the memory may be supplemental instruction for the specific course. The memory may also store specific teaching modules for all problems, including practice/exercise problems, any type of quizzes, chapter/standardized tests and any other questions associated with the coursework, such as textbooks, etc. The student may request help for a specific problem for the coursework. For example, the student may request help on problem 4 on page 53 of the textbook. Alternatively, the student may request help on a specific subject matter within the course, such as assistance on Pythagorean's Theorem.

The computing system then generates a teaching module, which may include problems and/or instructions for the student on the specific course. The generated teaching module is sent through the interface module 20 to the student on his student computer station 24. The screenshot 40 may be provided to the student, to include instruction and/or problems located within the tutor query section 44. The student is provided with an opportunity to question the tutoring system 10 at any point during the session. For example, the student may request help on a specific problem or step within the problem. The student may speak in his own natural language, which enables the student to “chat” with the computing system in a simple and convenient manner. The computing system receives the message from the student, interprets the message and generates an appropriate response through the artificial intelligence module 16. In the preferred embodiment of the present invention, the artificial intelligence module generates a response in a natural type language easily understood by the student. This puts the students at ease allowing them to be themselves and seek as much unlimited help as they want. Because of this invention, students do not feel shy or reluctant to ask any number of questions. The computing system instantly ascertains the intelligence level of each student. The computing system then provides the appropriate step-by-step instructions, hints, graphical images, and questions involved in the tutoring process until the student herself/himself arrives at the final answer that he or she is seeking for that particular problem or question from his/her textbook or any other specific curriculum material. This invention allows a student to think independently and come up with solutions and answers by himself/herself, thereby significantly increasing the motivation in the student and the quality of education. Thus, the student conducts the tutoring session in a conversation two-way communicative mode.

The tutoring session includes problems and instruction from the computing system. Unlike other existing tutoring programs, the present invention provides a conversational mode, which enables the student 22 at any point during the tutoring session to question the tutoring system 10. In addition, the tutoring system provides instant feedback at every step taken by the student. In the preferred embodiment of the present invention, the tutoring system provides positive feedback as appropriate. Positive feedback has been found universally to be effective in enhancing the student's learning process. The student may respond by any appropriate response upon the student response section 42. The student may use a keyboard at the student computer station and/or utilize the keyboard located on the student response section 42.

If the student desires live human help, the student may optional request such help by clicking the live help request section 52. A live tutor 32 is then connected from the tutor computer station 34 through the communication link 30 to the computing system. Alternatively, the tutor may be connected directly with the student without connecting through the computing system. The live tutor may then chat with the student in a conventional chat session. However, the present invention may enable the tutor to utilize a whiteboard to diagram solutions and problems to the student. Likewise, the student may utilize the whiteboard to response or query the tutor as necessary in a real-time environment. The live tutor provides an ancillary source for supplementing the tutoring system as necessary.

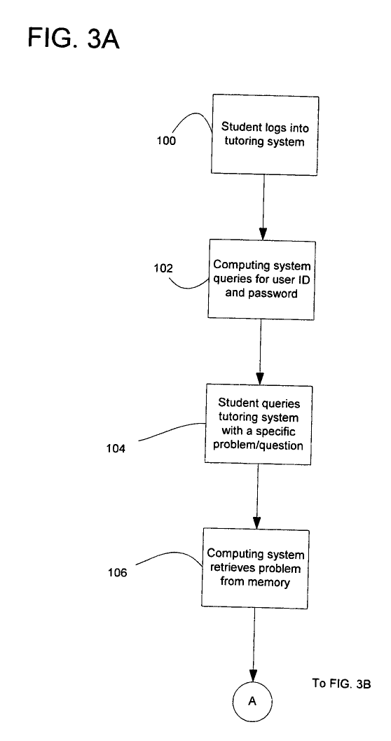

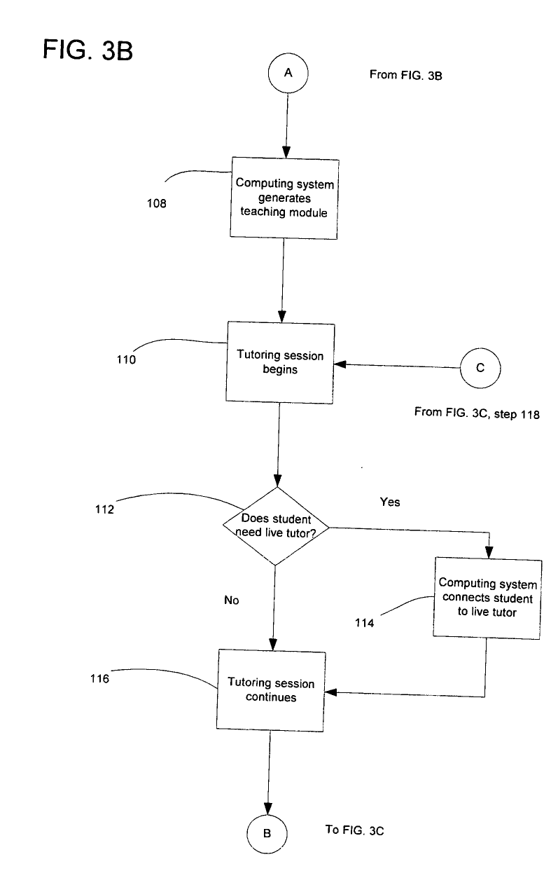

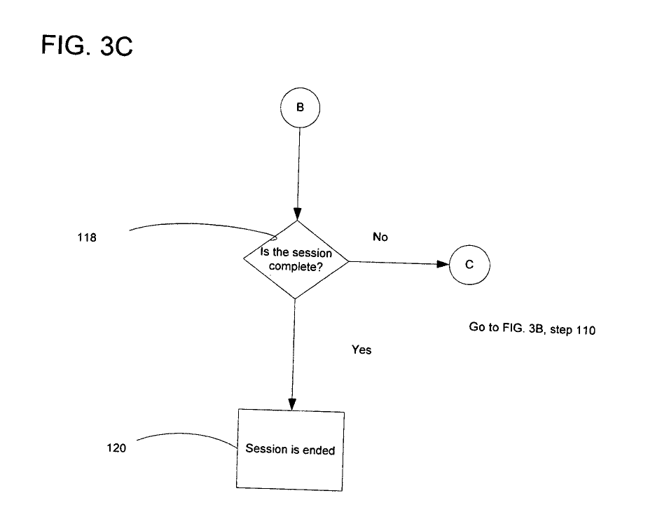

FIGS. 3A-3C are flow charts outlining the steps for utilizing the interactive tutoring system 10 according to the teachings of the present invention. With reference to FIGS. 1-3, the steps of the method will now be explained. In step 100, the student 22 logs into the interactive tutoring system through the student computer station 24. The student computer station connects through the communication link 26 to the interface module 20 of the computing system 12. In step 102, the computing system may query for a user identification and password from the student. The user identification and password may authenticate a student profile that includes a specific school district and other information assisting the tutoring system in identifying the student and his/her authorized use. Once the student is identified, the method moves to step 104 where the student may query the tutoring system with a specific problem/question from a specific course or on specific subject matter from their course curriculum materials such as their textbooks. For example, the student may select a specific textbook, page number and problem number to ask questions about. Next, in step 106, the computing system retrieves the problem or subject matter from the memory 18. In step 108, the computing system generates a teaching module to be utilized by the student in a step-by-step manner, and sends a screenshot 40 to the student on his student computer station 24.

The method then moves from step 108 to step 110 where the tutoring session begins. The computing system 12, through the artificial intelligence module 16, provides the teaching module to the student in a conversational mode. Specifically, the student may question any problem or step of the problem at any point during the session. In addition, the student may chat with the computing system using natural language. The tutoring session includes problems and instruction from the computing system. A conversational mode enables the student 22 at any point during the tutoring session to question the tutoring system 10, thereby providing an emulated one-on-one live teaching session. The tutoring system may also provide instant feedback, additional hints, relevant graphical images, and relevant intelligent questions at every step taken by the student. In the preferred embodiment of the present invention, the tutoring system provides positive feedback as appropriate. Positive feedback has been found universally to be effective in enhancing the student's learning process. The student may respond by any appropriate response upon the student response section 42. The student may use a keyboard at the student computer station and/or utilize the keyboard located on the student response section 42.

In step 112, during the tutoring session, the student may desire human assistance. In step 112, it is determined if the student desires human help. If the student wishes human help, the student selects the live help request 52 on the screenshot and the method moves to step 114. In step 114, the computing system connects the live tutor 32 with the student 22. Preferably, the live tutor is a highly qualified tutor in that subject matter. The live tutor 32 is then connected from the tutor computer station 34 through the communication link 30 to the computing system. Alternatively, the tutor may be connected directly with the student without connecting through the computing system. The live tutor may then chat with the student in a conventional chat session. However, the present invention enables the tutor to utilize a whiteboard to diagram solutions and problems to the student. Likewise, the student may utilize the whiteboard to response or query the tutor as necessary in a real-time environment. The live tutor provides a secondary source for supplementing the tutoring system as necessary. The method then continues with step 116 where the tutoring session continues.

However, in step 112 if it is determined that the student does not desire or need live tutoring assistance, the method moves from step 112 to step 116 where the tutoring session continues. Next, in step 118 it is determined if the session is complete. If the student wishes additional assistance, the method moves from step 118 to step 110 where the tutoring session continues. However, if it is determined that the tutoring session is complete, the method moves from step 118 to step 120 where the session ends. At the end of the session, an optional survey may be present to the student for feedback on the tutoring session.

Although the present invention may be utilized with a specific school course curriculum, the present invention may be used in any learning situation wherein a specific course curriculum and associated reference materials such as textbooks etc exist. For example, workers may utilize the present invention to be trained on specific tasks or learning objectives necessary to complete their jobs. In addition, the present invention may be used by college or university based students in their coursework. Furthermore, other than just the regular textbooks, the present invention may further support any other reference materials approved for a specific curriculum in any learning environment, including, but not limited to, additional supplementary coursework and non-coursework but academics related materials, test preparation books and materials, online coursework and non-coursework but academics related materials, online textbooks, online and offline academic digital contents, and educational training materials, etc.

The present invention provides many advantages over existing systems. The present invention is an interactive tutoring system. The system includes an artificial intelligence module, which provides a conversational mode between the student and the computing system. The computing system is able to interpret natural language from the student. In addition, throughout the tutoring session, the student is able to interact and question the computing system. The computing system may provide feedback to the student when appropriate. The tutoring system also may include a live tutor option for the student that allows a human tutor to ask or answer questions. The present invention provides a cost-effective and convenient forum for the student to obtain assistance in coursework of a school or in preparation for a standardized test, such as the SAT, state-mandated tests etc.

The tutoring system may support students who might need tutoring support in various languages other than English, including but not limited to, Spanish. The tutoring system may also support automatic text to voice conversion. Basically, each instruction generated by the teaching module in text may be automatically converted to voice, thereby providing a more fun learning environment for students during each session. Furthermore, the invention may also support a list of animated characters and/or photographs of tutors who can be selected by the students to conduct that specific tutoring session for the student. The lip movement in this scenario that automatically converts text to voice emulates an environment as if it is a live one-on-one tutoring session in progress with that preferred animated character or the actual tutor. Live voice support and/or two-way video conferencing may also be possible when a student opts for a live tutor.

In order to provide consolidated feedback to the parents, school authorities, and any other educators, the present invention also automatically captures all data thereby facilitating report generation. After the session ends, each of the session, including live sessions, are captured and archived in memory 18 for later review, quality enhancements, and report generation. In addition, the data on student login/logout times, hours spent per day, hours spent per problem/topic/subject matter, student performance index per session/overall, student satisfaction index per session/overall, and other data are captured. These efforts translate into a system of identifying and analyzing the performance & IQ progress of individual students over a period of time. With all of this data generated, the tutoring system may provide detailed metrics & graphical reports to district authorities, parents, and any other educators, thereby providing a quantifiable means of evaluating the effectiveness of the present invention in influencing academic performance benchmarks for each student.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. An interactive tutorial system, the system comprising:
a computing system having an artificial intelligence module and a memory module; and
a student computer station for use by a student desiring tutoring in a specific subject matter, the student computer station communicating with the computing system;
the artificial intelligence module generating instruction on the specific subject matter stored within the memory module for the student, the artificial intelligence capable of interacting with the student in a two-way conversational mode.

2. The interactive tutorial system of claim 1 wherein the memory stores information on a teaching module for coursework for which the student is receiving tutoring.

3. The interactive tutorial system of claim 1 wherein the student computer station communicates via the Internet to communicate with the computing system.

4. The interactive tutorial system of claim 1 wherein the subject matter is associated with a specific curriculum.

5. The interactive tutorial system of claim 4 wherein the specific curriculum includes problems associated with a course load, the problems and an associated step-by-step teaching module solution being stored within the memory module.

6. The interactive tutorial system of claim 1 further comprising:
means for communicating with a live tutor, the live tutor providing instruction on the specified subject matter.

7. The interactive tutorial system of claim 6 wherein the means for communicating with a live tutor includes a whiteboard providing real-time communication of both textual and non-textual contents.

8. The interactive tutorial system of claim 1 wherein the computing system includes an interface module for interfacing with the student through the student computer station.

9. The interactive tutorial system of claim 1 wherein the artificial intelligence provides feedback on tasks completed by the student.

10. A method of providing an interactive tutorial session to a student in a specific subject matter, the method comprising the steps of:
initiating contact with a computing system by a student via a student computer station, the computing system having artificial intelligence and a memory storing information on the specific subject matter;
selecting a specific subject matter for which the student needs tutoring;
querying by the student on a specific problem or question on the specific subject matter;
responding by the computing system by generating a teaching module on the specific problem or question on the specific subject matter; and
engaging in a two-way conversation between the computing system and the student on the specific problem or question on the specific subject matter.

11. The method of providing an interactive tutorial session to a student in a specific subject matter of claim 10 wherein the specific subject matter includes reference materials from a specific course curriculum.

12. The method of providing an interactive tutorial session to a student in a specific subject matter of claim 11 wherein:
the specific course curriculum includes problems and questions, the problems, questions and solutions being stored in the memory; and
the computing system providing tutoring on a specific problem or question queried by the student.

13. The method of providing an interactive tutorial session to a student in a specific subject matter of claim 10 further comprising the steps of:
requesting by the student additional tutoring from a live tutor;
connecting a live tutor with the student by the computing system; and
tutoring by the live tutor to the student.

14. The method of providing an interactive tutorial session to a student in a specific subject matter of claim 13 wherein the student communicates with the live tutor utilizing a whiteboard to communicate both textual and non-textual contents.

15. The method of providing an interactive tutorial session to a student in a specific subject matter of claim 10 wherein the computing system provides feedback in reaction to tasks accomplished by the student.

16. An interactive tutorial system, the system comprising:
a computing system having an artificial intelligence module and a memory module, the memory storing information on a specific course curriculum; and
a student computer station for use by a student desiring tutoring in the specific course curriculum, the student computer station communicating with the computing system;
the artificial intelligence module generating instruction stored within the memory module for the student, the artificial intelligence capable of responding to any query by the student, the artificial intelligence capable of providing feedback on each task accomplished by the student.

17. The interactive tutorial system of claim 16 further comprising means for communicating with a live tutor, the live tutor providing instruction on the specified course curriculum.

18. The interactive tutorial system of claim 16 wherein the instruction includes step-by-step teaching module solutions for problems and questions used in course material assigned to the students in the specific course curriculum.

19. The interactive tutorial system of claim 16 further comprising means for supporting automatic text to voice conversion with graphics and audio to represent a tutor.

20. The interactive tutorial system of claim 16 further comprising means for archiving a session and any associated data conducted between the student and the computing system.
